(19) United States
(12) Patent Application Publication
(10) Pub. No.: US 2012/0050782 A1
(43) Pub. Date: Mar. 1, 2012

(54) INFORMATION PROCESSING APPARATUS, ERROR DISPLAY METHOD, AND STORAGE MEDIUM

(75) Inventor: Keiji Kawasaki, Yokohama-shi (JP)

(73) Assignee: CANON KABUSHIKI KAISHA, Tokyo (JP)

(21) Appl. No.: 13/217,648

(22) Filed: Aug. 25, 2011

(30) Foreign Application Priority Data
Aug. 31, 2010 (JP) 2010-194153

(51) Int. Cl. G06K 15/02

(52) U.S. Cl. 358/1.14

(57) ABSTRACT

An information processing apparatus, which uses a management unit configured to manage a print job, comprises a command generation module, which includes a detection unit configured to detect a setting error in the print job and a transmission unit configured to, if it is determined that the detection unit detects the setting error in the print job, transmit a command including information about the setting error, a command analysis module configured to, if it is determined that the command including the information about the setting error is received, request an error display, and an error display module which includes a display unit configured to, based on the information about the setting error, display corresponding error information on a display device in response to a request from the command analysis module.

### BACKGROUND OF THE INVENTION

1. Field of the Invention

The present invention relates to an information processing apparatus, an error display method, and a storage medium.

2. Description of the Related Art

Conventionally, a user is notified of errors that have occurred in a printing apparatus and the status of the printing apparatus by a printing control apparatus. For example, a command transmission/reception unit in the printing control apparatus acquires the status of the printing apparatus, and notifies this status to a status information display unit, which displays the status.

For example, Japanese Patent Application Laid-Open No. 2008-305142 discusses a technique in which a printing control apparatus temporarily stops the transfer of a print command to the printing apparatus and issues a warning when the contents of the print command being transmitted to the printing apparatus and the setting information for the printing apparatus are an inappropriate combination.

Usually, when a print request is received from an application, a printing control apparatus generates a print command via a command generation unit, and transmits the print command to the printing apparatus via a command transmission/reception unit. However, there are print requests for which a print command is not generated, such as a print request for form file generation. When a print request for form file generation is received, the printing apparatus completes the print request by generating and storing the form file. In this case, no commands reach the command transmission/reception unit.

However, some errors that occur during the processing of a print command (e.g., a setting error in a print job) cannot be displayed on the command generation unit due to the nature of the processes operated by the command generation unit. Further, if the printing control apparatus receives a print request that does not generate a print command, no commands reach the command transmission/reception unit. Therefore, the command generation unit cannot notice any errors from the print command. In such a situation, a print job setting error may not be displayed.

Further, when the printing apparatus receives a part of a print command, it performs an initialization operation to prepare for printing. However, in the technique discussed in Japanese Patent Application Laid-Open No. 2008-305142, when an error occurs during processing of a print request, the printing control apparatus temporarily stops the transfer of the print command to the printing apparatus and issues a warning. Consequently, there is the issue that the printing apparatus performs an unnecessary initialization operation.

### SUMMARY OF THE INVENTION

The present invention is directed to displaying a setting error in a print job more appropriately.

According to an aspect of the present invention, an information processing apparatus which uses a management unit configured to manage a print job includes a command generation module, which includes a detection unit configured to detect a setting error in the print job, and a transmission unit configured to, if it is determined that the detection unit detects the setting error in the print job, transmit a command including information about the setting error, a command analysis module configured to, if it is determined that the command including the information about the setting error is received, request an error display, and an error display module which includes a display unit configured to, based on the information about the setting error, display corresponding error information on a display device in response to a request from the command analysis module.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a hardware configuration.

FIG. 2 illustrates an example of a function configuration in a personal computer.

FIG. 3 illustrates an example of a print mode table.

FIG. 4 illustrates an example of main processing.

FIG. 5 illustrates an example of print setting consistency determination processing.

FIG. 6 illustrates an example of print processing.

FIG. 7 illustrates an example of form file generation processing.

FIG. 8 illustrates an example of form composite print processing.

FIGS. 9A to 9C illustrate examples of form file structures.

FIG. 10 illustrates an example of a data structure of a setting error notification command.

FIG. 11 illustrates an example of language monitor processing.

FIG. 12 illustrates an example of an error screen.

FIG. 13 illustrates an example of main processing.

FIG. 14 illustrates an example of main processing.

### DESCRIPTION OF THE EMBODIMENTS

Various exemplary embodiments, features, and aspects of the invention will be described in detail below with reference to the drawings.

The exemplary embodiments do not limit the present invention. Further, not all of the structures described in the exemplary embodiments are essential in order to solve the problems that the present invention is directed to resolving.

### (Hardware Configuration)

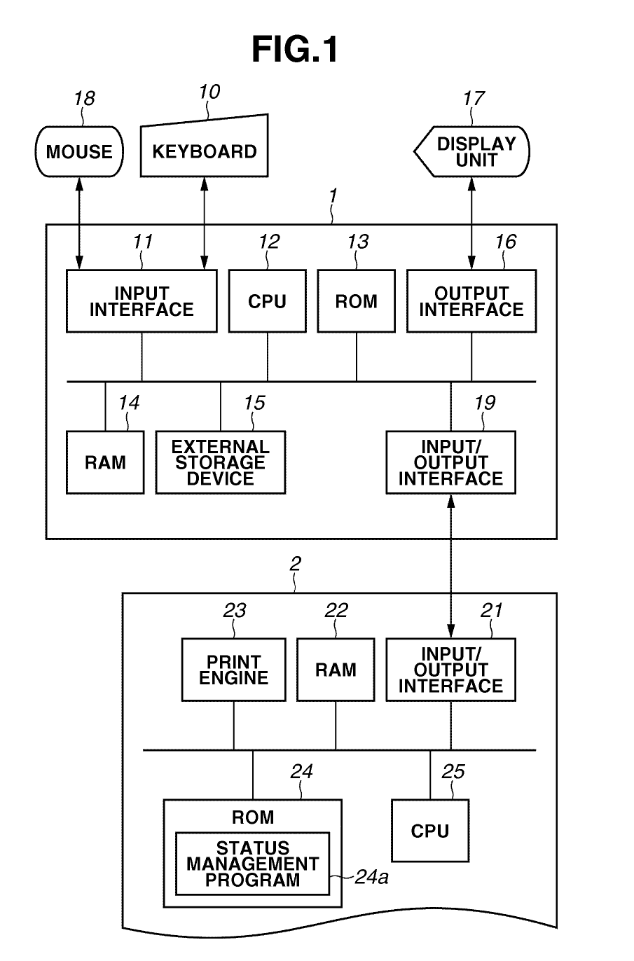

The configuration of a printing system that includes a printing apparatus 2 and a personal computer 1 connected to the printing apparatus 2 will be described with reference to FIG. 1. FIG. 1 illustrates an example of the hardware configuration of the personal computer 1 and an example of the hardware configuration of the printing apparatus 2.

The personal computer 1 is an example of an information processing apparatus (computer), which includes an input interface 11, a central processing unit (CPU) 12, a read-only memory (ROM) 13, a random access memory (RAM) 14, an external storage device 15, an output interface 16, and an input/output interface 19. Input devices such as a keyboard 10 and a mouse 18 are connected to the input interface 11, and a display device such as a display unit 17 is connected to the output interface 16.

An initialization program is stored in the ROM 13. An application program group, an operating system (OS), a printer driver, and various kinds of data pieces are stored in the external storage device 15. For example, the RAM 14 is used as a work memory by the various programs stored in the external storage device 15. In the present exemplary embodiment, the CPU 12 realizes the below-described functions and the processing illustrated in the below-described flowcharts performed in the personal computer 1 by executing processing based on procedures of the programs stored in the ROM 13.

The printing apparatus 2 includes an input/output interface 21, a RAM 22, a print engine 23, a ROM 24, and a CPU 25.

The input/output interface 21 is connected to the input/output interface 19 in the personal computer 1. Although the present exemplary embodiment is described based on the assumption that the connection interface is a universal serial bus (USB (registered trademark)), the present invention is not limited to this. In addition, an expansion option for expanding the functions of the printing apparatus 2 may be connected to the input/output interface 21.

The RAM 22 is used as a main memory and a work memory for the CPU 25. Further, the RAM 22 is used as a receiving buffer for temporarily storing received print jobs, and also for storing various data pieces. The print engine 23 performs printing based on the data stored in the RAM 22. The ROM 24 stores a status management program 24a, various control programs, and data pieces that are used by the various control programs. The CPU 25 controls each of the units in the printing apparatus 2 based on these control programs.

The status management program 24a is a program that monitors the state of the printing apparatus 2 based on information from various sensors (not illustrated) in the printing apparatus 2, generates status information and stores it in the RAM 22 In the present exemplary embodiment, although the processing performed by the personal computer 1 and the printing apparatus 2 is assigned as described above, the present invention is not limited to this. The processing may be assigned as appropriate.

### (Function Configuration)

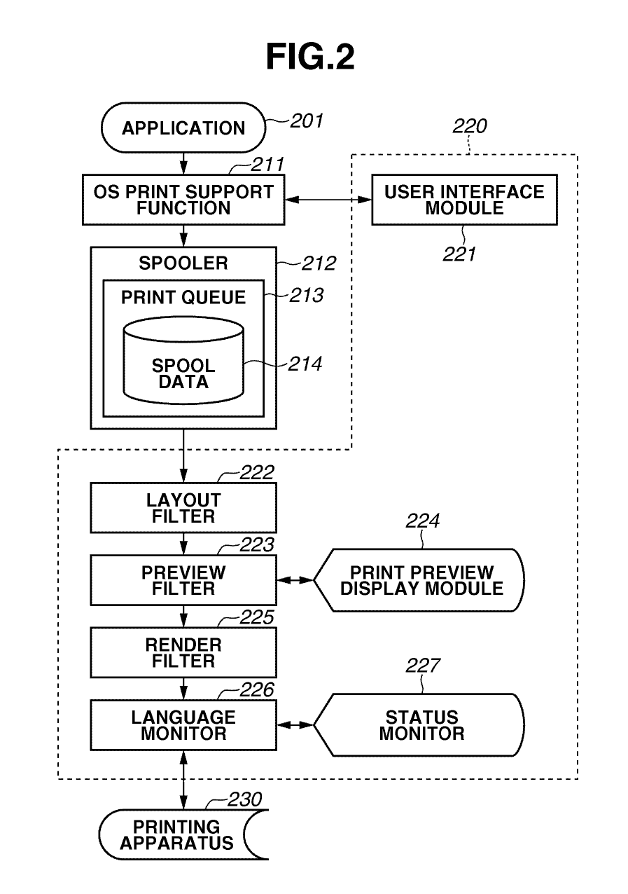

FIG. 2 illustrates an example of a function configuration in the personal computer 1. FIG. 2 mainly illustrates the function of a printer driver 220 installed in the personal computer 1. The present printing system will be described based on the example of using Windows (registered trademark) from Microsoft Corporation as the OS in the personal computer 1. Further, extensible markup language (XML) paper specification (XPS), which is an open standard electronic document format developed by Microsoft Corporation, will be used for the spool data.

Print data generated by an application 201 is temporarily stored in a print queue 213 in a spooler 212 as spool data 214 via an OS printing support function 211. The spool data 214 is managed by the spooler 212 as a print job to which a name, for example, has been added. The spooler 212 is an example of a management unit for managing the print jobs. The print job is converted into a print command that can be interpreted by a printing apparatus 230 (the printing apparatus 2) using the printer driver 220, and the print command is supplied to the printing apparatus 230 for printing.

When the application 201 instructs printing to start based on an input device operation (user operation) by the user, the application 201 adds to the print job the print setting information that has returned from a user interface module 221 via the OS printing support function 211. The print setting information is set in advance before the instruction to start printing from the application 201.

The print job is transferred to the printer driver 220, and then processed by a layout filter 222. The “filter” is a program (module) having a function for outputting some kind of data via a step such as processing, conversion, non-conversion, and generation based on the input data. The filter is called from an OS filter management function (not illustrated). The layout filter 222 performs page configuration processing on a print job for rearranging pages in the print job and gathering a plurality of pages into a single page based on the print setting information.

Next, the print job is transferred to a preview filter 223. If the preview filter 223 determines that the print setting information includes an instruction for displaying a print preview screen, the preview filter 223 calls a print preview display module 224. The print preview display module 224 is displayed on the display unit 17 in the personal computer 1 to provide means for the user to confirm in advance the results of printing. On the other hand, if the preview filter 223 determines that the print setting information does not include an instruction for displaying a print preview screen, the preview filter 223 transfers the print job to a render filter 225.

The render filter 225 is an example of a command generation module. The render filter 225 converts the print job into a print command that can be interpreted by the printing apparatus 230 based on the print setting information. The print commands transmitted by the render filter 225 are sequentially transmitted via a filter management function (not illustrated) and the spooler 212, and then on to the printing apparatus 230 by a language monitor 226.

The language monitor 226 is an example of a command analysis module. The language monitor 226 reads the state of the printing apparatus 230 based on information about occurrence of error in the printing apparatus 230 and information about the page that is currently being printed, and transfers the read status to a status monitor 227. The status monitor 227 is an example of an error display module. The status monitor 227 provides means for the user to confirm the state of the print job and the state of the printing apparatus 230. The status monitor 227 analyzes the state of the printing apparatus 230 and displays information about the printing apparatus 230 on the display unit 17 in the personal computer 1.

### (Transparent Ink)

In the present exemplary embodiment, the printing apparatus 230 uses transparent ink in addition to color inks such as cyan, magenta, yellow, and black (CMYK). Transparent ink is used to provide uniform gloss to an image and to expand the color gamut. The transparent ink can also provide a decorative effect by not coating the ink on a specific region.

The printer driver 220 has three modes as methods for coating the transparent ink, these are a whole surface coating mode, an automatic coating mode, and a user setting mode. In the whole surface coating mode, the transparent ink is coated over the whole print range of a print medium. In the automatic coating mode, for a print medium that does not require the transparent ink, the transparent ink is not coated, while for a print medium that does require the transparent ink, the transparent ink is coated to a region other than a white spot region in the print data. More specifically, the automatic coating mode switches between whether the transparent ink needs to be coated or not based on a print medium setting value in the print setting information.

The user setting mode allows the user to design a print product by varying how the print product will look by not coating the transparent ink on a portion of the print medium. The user setting mode has two modes, a form file generation mode and a form composite print mode. In the form file generation mode, a region where the transparent ink is not to be coated (transparent ink deletion region) is generated and stored as a form file. In the form composite print mode, printing is performed without coating the transparent ink on only regions specified by the transparent ink deletion region included in the form file selected based on a user operation.

The transparent ink coating mode that can be used is different according to the print mode which is determined based on a combination of setting values. The print modes are classified into the following three types. The print modes will be described in more detail below.

Print mode that can used “automatic coating mode”/“whole surface coating mode”/“user setting mode (form file generation mode/form composite print mode)”

Print mode that can use “automatic coating mode”/“whole surface coating mode”

Print mode that can use only “automatic coating mode”

In the print mode that can use only the “automatic coating mode”, the transparent ink is not coated. For print media for which the effect of transparent ink is low, such as plain paper and a matte coated print medium, only the “automatic coating mode” can be used as the transparent ink coating mode, because the color conversion and print control methods have been designed based on the assumption that transparent ink will not be used. Thus, the “automatic coating mode” in this case indicates that “transparent ink will not be coated”.

On the other hand, for print media that can achieve a uniform glossiness effect by using the transparent ink, the “automatic coating mode” and the “whole surface coating mode”, in which the transparent ink is coated, can be used. For these types of print media, it depends on the print mode whether the “user setting mode” can be used. This is because the print mode that cannot easily achieve a decorative effect using transparent ink, such as a print mode that places priority on speed, is set so that only “automatic coating mode” and “whole surface coating mode” can be used. Such setting can prevent occurrence of an issue that a desired printing effect cannot be obtained by using the user setting mode in the print mode in which it is difficult to achieve a decorative effect.

Similar to the form composite print mode in the “user setting mode”, the print modes that can be used in the form file generation mode are also restricted. Such restriction is to prevent an issue that the generated form file is not correctly composited due to differences in the resolution of the respective print modes.

For example, when a form file generated by a speed-priority print mode with a resolution of 300 dpi is composited with a form file generated by a quality-priority print mode with a resolution of 600 dpi, the result is that the form is applied on only a portion of the print range. Setting so that the print modes capable of utilizing the form file generation mode and the form composite print mode are the same enables mismatches in resolution to be avoided as much as possible. Further, by setting so that the print modes capable of utilizing the “user setting mode” are all the same resolution, mismatches in resolution can be completely avoided.

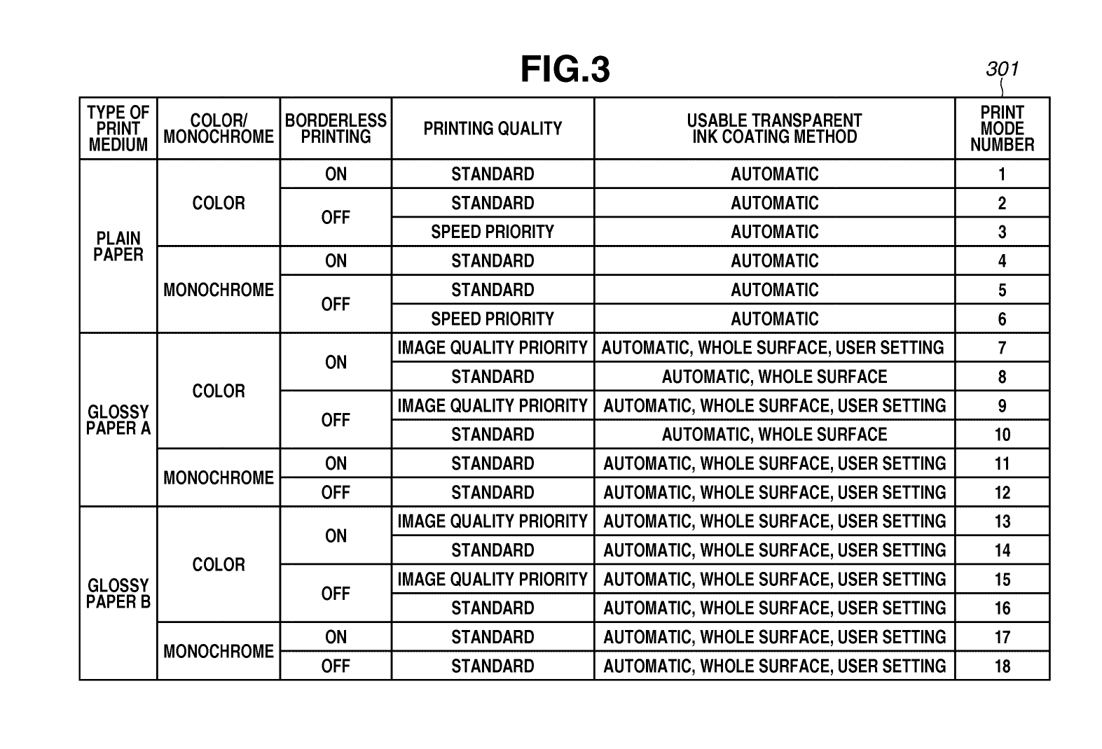

FIG. 3 illustrates an example of a print mode table (print mode table 301) that stores information relating to the transparent ink coating modes that can be used for each print mode.

For example, the table indicates that all of the automatic coating mode, the whole surface coating mode, and the user setting mode can be used in the print mode (7) of “glossy paper A, color, borderless printing ON, image quality priority”. Further, the table indicates that only the automatic coating mode and the whole surface coating mode can be used the print mode (8) of “glossy paper A, color, borderless printing ON, standard”.

Since the color conversion and print control methods are thus determined based on the setting values from the type of print medium, which is the top setting item, to the print quality, which is the bottom setting item, in the present exemplary embodiment each and every combination of these setting values is termed a print mode.

### (Main Processing)

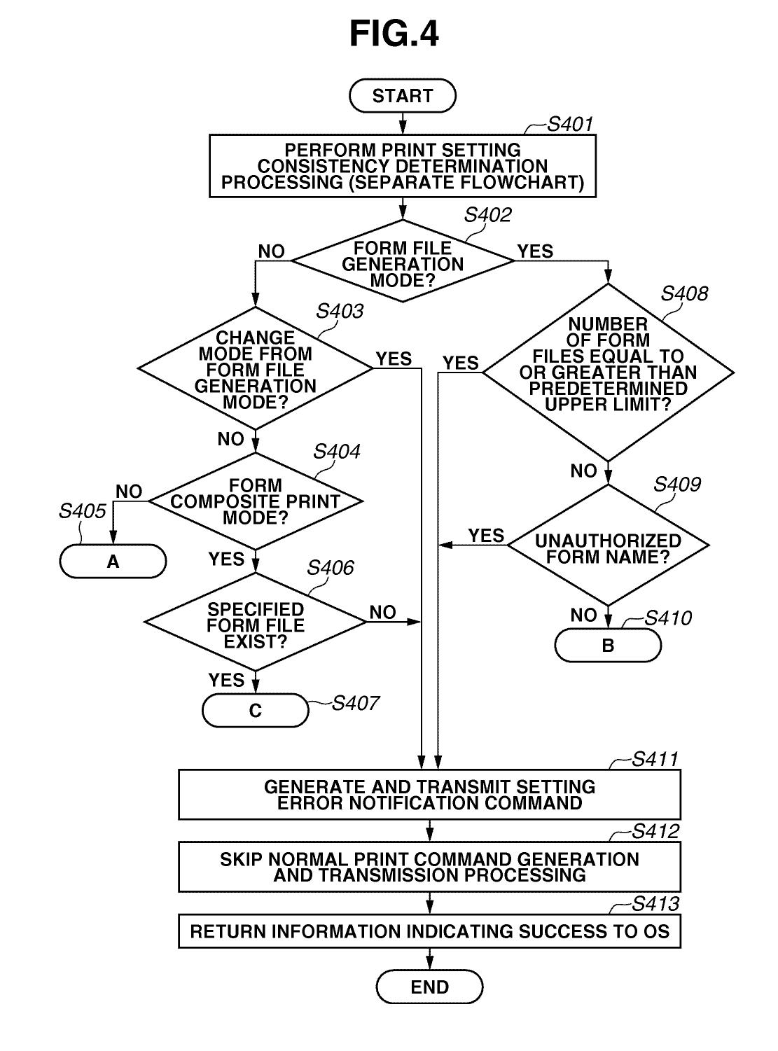

FIG. 4 illustrates an example of a flowchart according to a main processing program executed by the render filter 225. The processing is focused on determination of a setting error relating to the transparent ink coating mode. When printing is instructed to start, in step S401, the render filter 225 performs print setting consistency determination processing for changing the setting values of some of the items. This processing is performed by referring to the print setting information in a print job to determine whether there are any inconsistencies among the setting items (combinations of setting values that cannot be used).

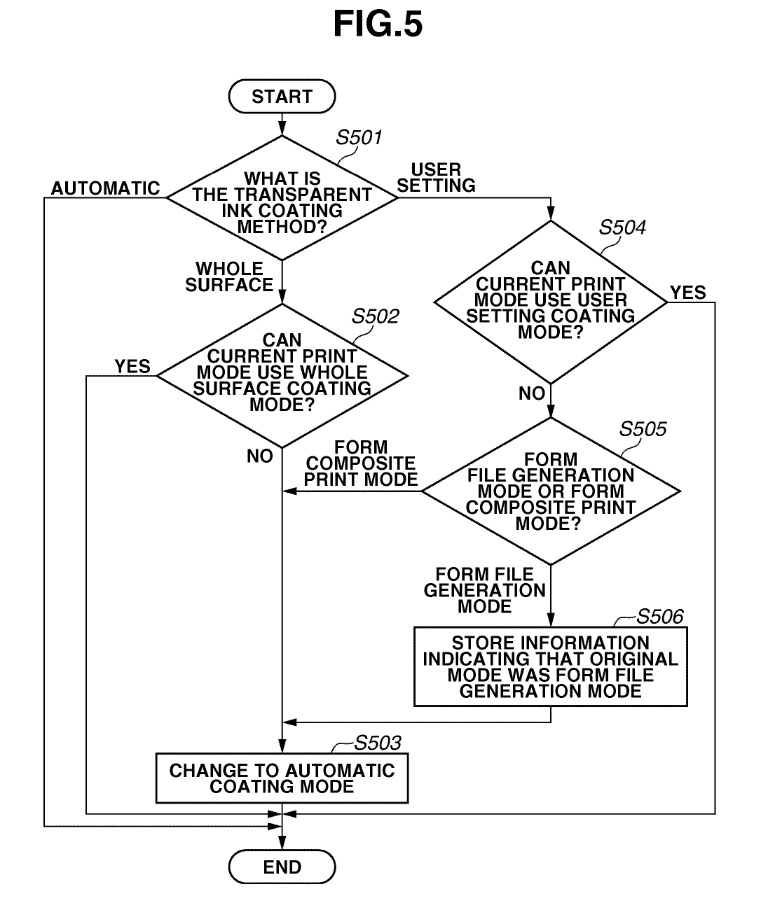

The print setting consistency determination processing performed by the render filter 225 in step S401 will be described in detail with reference to FIG. 5. FIG. 5 illustrates an example of a flowchart according to a print setting consistency detection processing program.

First, in step S501, the render filter 225 determines the transparent ink coating method by referring to the setting value of the transparent ink coating mode from the print setting information. If the render filter 225 determines that the transparent ink coating mode setting value indicates the automatic coating mode (AUTOMATIC in step S501), since the automatic coating mode can be used in all print modes, the render filter 225 determines that there are no inconsistencies, and thus finishes the print setting consistency detection processing.

If the render filter 225 determines that the transparent ink coating mode is the whole surface coating mode (WHOLE SURFACE in step S501), the processing proceeds to step S502. In step S502, the render filter 225 determines whether the whole surface coating mode can be used by the print mode corresponding to the current setting by referring to the print mode table 301. If the render filter 225 determines that the whole surface coating mode can be used (YES in step S502), since there are no inconsistencies, the render filter 225 simply finishes the processing. On the other hand, if the render filter 225 determines that the whole surface coating mode cannot be used by the set print mode (NO in step S502), the processing proceeds to step S503. In step S503, the render filter 225 changes the transparent ink coating mode to the automatic coating mode, and then finishes the processing.

If the render filter 225 determines that the transparent ink coating mode is the user setting mode (USER SETTING in step S501), the processing proceeds to step S504. In step S504, the render filter 225 determines whether the user setting mode can be used by the print mode corresponding to the current setting by referring to the print mode table 301. If the render filter 225 determines that the user setting mode can be used (YES in step S504), since there are no inconsistencies, the render filter 225 simply finishes the processing. On the other hand, if the render filter 225 determines that the user setting mode cannot be used by the set print mode (NO in step S504), the processing proceeds to step S505. In step S505, the render filter 225 further determines whether the user setting mode is the form file generation mode or the form composite print mode.

If the render filter 225 determines that the user setting mode is the form composite print mode (FORM COMPOSITE PRINT MODE in step S505), the processing proceeds to step S503. In step S503, the render filter 225 changes the transparent ink coating mode to the automatic coating mode, and then finishes the processing. If the render filter 225 determines that the user setting mode is the form file generation mode (FORM FILE GENERATION MODE in step S505), the processing proceeds to step S506. In step S506, the render filter 225 stores information indicating that the original mode in the print setting information is the form file generation mode in the RAM 14, and the processing then proceeds to step S503. In step S503, the render filter 225 changes the transparent ink coating mode to the automatic coating mode, and then finishes the processing.

Returning to FIG. 4, in step S402, the render filter 225 determines whether the transparent ink coating mode is the form file generation mode by referring to the print setting information changed as necessary by the processing performed in step S401. If the render filter 225 determines that the transparent ink coating mode is not the form file generation mode (NO in step S402), the processing proceeds to step S403. In step S403, the render filter 225 determines whether the mode was changed in step S401 from the form file generation mode to the automatic coating mode (another transparent ink coating mode) by referring to the information stored in the RAM 14 in step S506. If it is determined that the mode was changed (YES in step S403), the render filter 225 executes error display processing in step S411 onwards. In step S411 onwards, the render filter 225 notifies the user of corresponding error information, and refrains from performing the print processing or the form generation processing. The processing from step S411 onwards will be described below.

The reason why an error is determined to have occurred if it is determined in step S403 that the mode has been changed is to avoid unnecessary consumption of the print medium due to print processing not expected by the user. In the form file generation mode, a form file is only generated but not printed. However, if processing is continued after having changed the mode in step S401, printing will be performed. More specifically, the user who has specified the form file generation does not expect output processing onto the print medium to be performed. If unexpected output processing occurs, this will result in wasteful consumption of the print medium, which is not desirable.

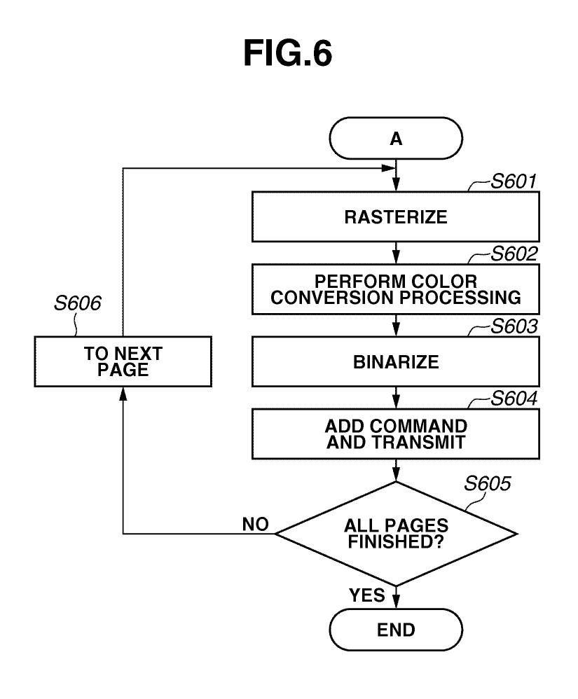

On the other hand, if it is determined in step S403 that the mode was not changed (NO in step S403), in step S404, the render filter 225 determines whether the transparent ink coating mode is the form composite print mode. If the render filter 225 determines that the transparent ink coating mode is not the form composite print mode (NO in step S404), in step S405, normal print processing is performed that does not use a form file. The processing performed in step S405 will be described in more detail below using a separate flowchart (FIG. 6). On the other hand, if the render filter 225 determines that the transparent ink coating mode is the form composite print mode (YES in step S404), then in step S406, the render filter 225 determines whether the specified form file exists in the external storage device 15 by referring to the print setting information.

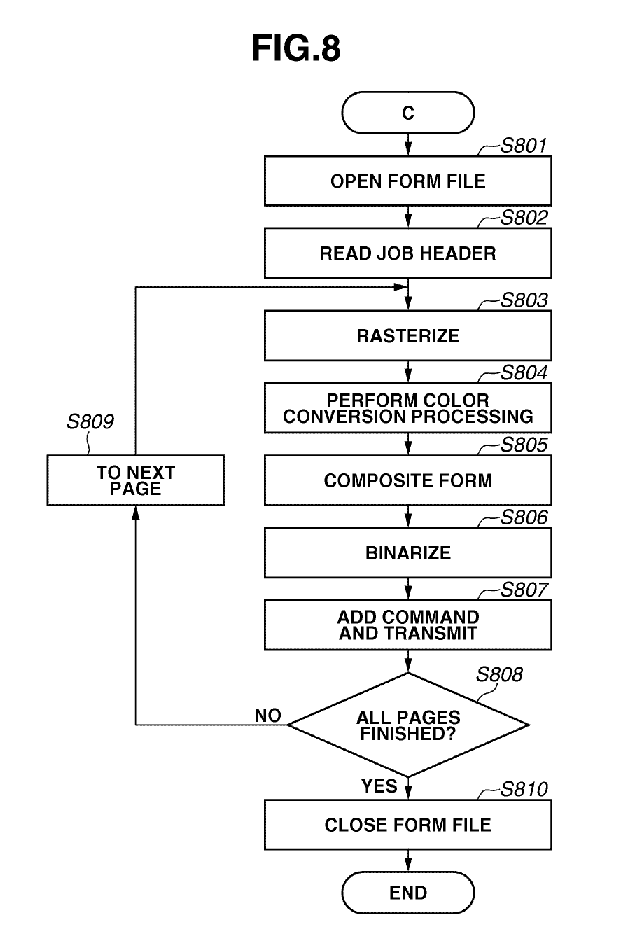

If the render filter 225 determines that the specified form file exists (YES in step S406), in step S407, the render filter 225 performs form composite print processing using the form file. The processing performed in step S407 will be described in more detail below using a separate flowchart (FIG. 8). On the other hand, if the render filter 225 determines that the specified form file does not exist (NO in step S406), the render filter 225 performs the error display processing in step S411 onwards.

Further, if it is determined in step S402 that the transparent ink coating mode is the form file generation mode (YES in step S402), in step S408, the render filter 225 checks whether the number of form files in the external storage device 15 is equal to or greater than a predetermined upper limit. If it is determined such a number of form files does exist in the external storage device 15 (YES in step S408), the render filter 225 performs the error display processing in step S411 onwards. The processing in step S408 is performed in order to prevent the external storage device 15 from becoming overly strained due to a large amount of form files being generated.

On the other hand, if it is determined that the number of form files is under the predetermined upper limit (NO in step S408), in step S409, the render filter 225 determines whether the correct form name is specified by referring form names in the print setting information. The processing in step S409 is performed in order to avoid unintended generation or overwriting of form files. In step S409, the render filter 225 determines that the form name is correct if it determines that the form name is not blank and that there are no existing form files with the same name.

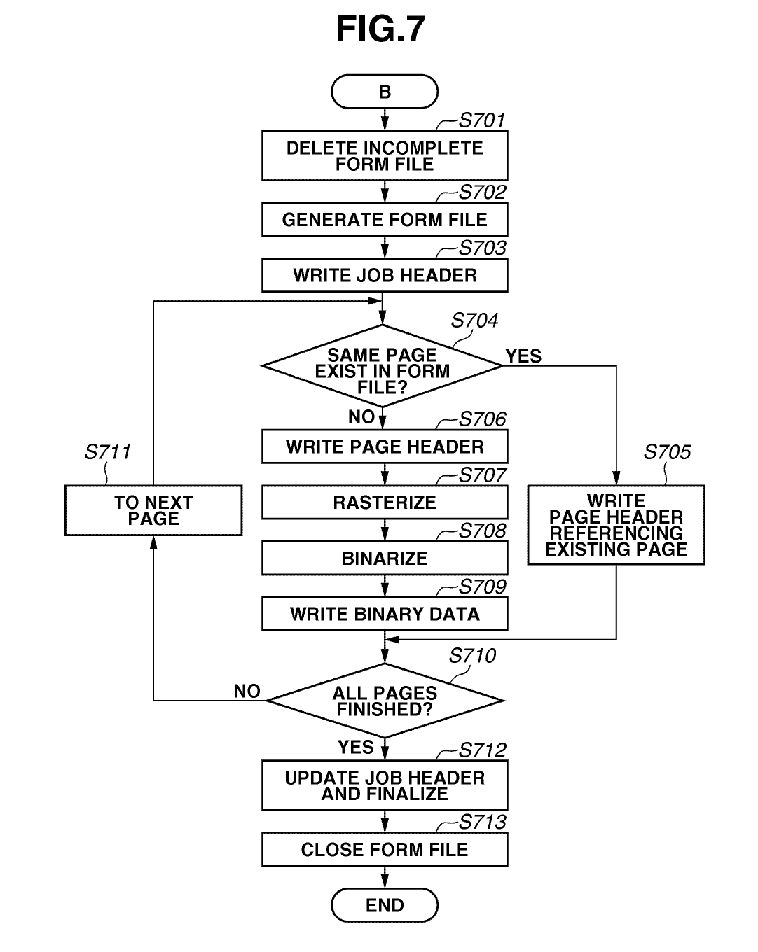

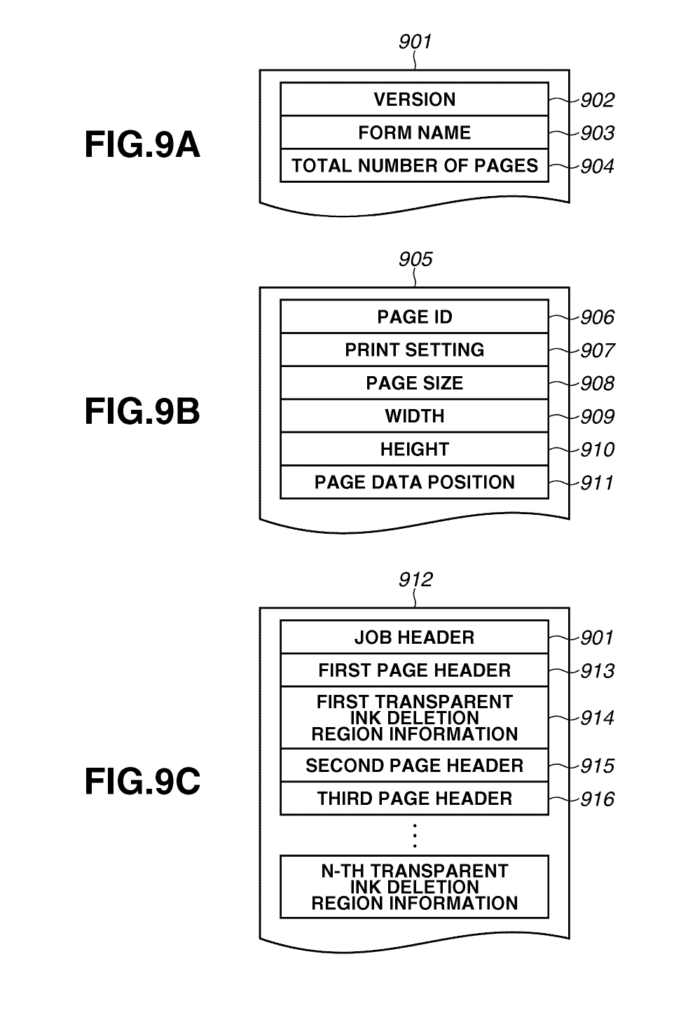

If it is determined that the form name is correct (NO in step S409), the processing proceeds to step S410. In step S410, the render filter 225 performs form file generation processing. The processing performed in step S410 will be described in more detail below using a separate flowchart (FIG. 7). Further, the structure of the form file will be described below using FIGS. 9A to 9C. On the other hand, if it is determined that the form name is incorrect (YES in step S409), the render filter 225 performs the error display processing in step S411 onwards.

Next, the error display processing in step S411 onwards will be described that is executed when any of the above-described plurality of determinations (steps S403, S406, S408, and S409) is satisfied.

In step S411, the render filter 225 generates and transmits a setting error notification command for notifying the user of occurrence of a setting error (detection of the setting error). The command transmitted by the render filter 225, basically, is transmitted via a filter management function (not illustrated) and the spooler 212 to the printing apparatus 230 by the language monitor 226. However, when the language monitor 226 receives the setting error notification command, the language monitor 226 performs processing for notifying the user that the setting error has occurred without transmitting the setting error notification command to the printing apparatus 230. The processing performed by the language monitor 226 will be described in more detail below.

As illustrated in the flowchart in FIG. 4, the personal computer 1 does not transmit other print commands before transmitting the setting error notification command in step S411. More specifically, if a setting error has occurred, no commands reach the printing apparatus 230 throughout the entire processing of the print job. Consequently, when the setting error has occurred, the printing apparatus 230 can avoid an unnecessary initialization operation.

Depending on the printing system, the setting error notification command transmitted by the render filter 225 may reach the printing apparatus 230 without passing through the language monitor 226. In this case, the printing apparatus 230 is configured so that it is not incorrectly operated even if it receives the setting error notification command. For example, when the setting error notification command is received, rather than performing an initialization operation in response to the setting error notification command, the printing apparatus 230 performs processing such as throwing out (discarding) the setting error notification command.

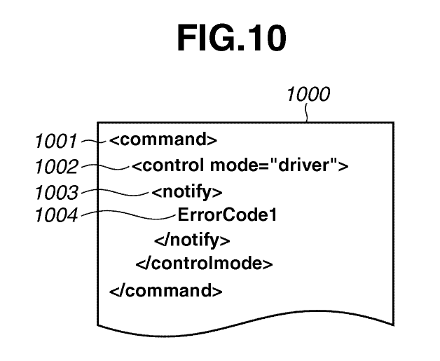

The data structure of the setting error notification command will be described using FIG. 10. FIG. 10 illustrates an example of the setting error notification command data structure.

A <command> element 1001 indicates the start of the command. A <control mode=“driver”> element 1002 indicates a target to be controlled by the command. The attribute value “driver” is set in a mode attribute of a control tag. More specifically, the attribute value indicates that the command is a command for controlling the printer driver 220. A <notify> element 1003 indicates specific notification contents. Data “ErrorCode1” (1004) is set in the <notify> element 1003.

When the language monitor 226 receives the data ErrorCode1 (1004), it recognizes that the data indicates the setting error. In the element 1003, data ErrorCode corresponding to the error contents is set by the render filter 225. The data in the element 1003 is referred to recognize the type of the error by the language monitor 226. In the present exemplary embodiment, the render filter 225 sets the corresponding ErrorCode data based on which error condition is satisfied in steps S403, S406, S408, or S409.

After the render filter 225 has transmitted the setting error notification command in step S411, in step S412, the render filter 225 skips all of the normal print command generation processing and the transmission processing (hereinafter, collectively referred to as “normal print command generation processing”). In the printer driver 220, which uses XPS data for the print spool, each filter can control by itself the acquisition timing and the acquired amount of the XPS data, which is the print job. Therefore, the render filter 225 realizes the skip processing simply by not acquiring the XPS data.

Then, after skipping all of the normal print command generation processing, in step S413, the render filter 225 returns information indicating successful processing to the filter management function of the OS, which is the calling source of the render filter 225. More specifically, although the render filter 225 internally skips the normal print command generation processing, it finishes the processing as if it was successful in generating the setting error notification command.

In addition, the command transmitted by the render filter 225 reaches the language monitor 226 via the filter management function of the OS and the spooler 212. To optimize the transfer processing, the filter management function of the OS and the spooler 212 do not immediately transfer the received command, they store a certain amount and then transfer the commands. Therefore, the setting error notification command transmitted in step S411 by the render filter 225 may not have reached the language monitor 226 even if the processing has proceeded on from step S412.

Normally, when an error occurs that prevents the render filter 225 from continuing processing, the render filter 225 interrupts the normal print command generation processing, and then returns information indicating failure of the processing to the filter management function of the OS. Consequently, modules other than the printer driver 220 are notified to stop processing, which allows the print job to be quickly stopped. However, in this case, the print commands transmitted by the render filter 225 and stored in the filter management function of the OS and the spooler 212 are not guaranteed of reaching the language monitor 226 before processing is stopped.

Therefore, as illustrated in step S413, when the render filter 225 returns information indicating success to the filter management function of the OS, the filter management function of the OS transmits all of the print commands to the language monitor 226 before the print job is finished. Consequently, the print commands transmitted by the render filter 225 can be guaranteed to reach the language monitor 226. More specifically, due to the render filter 225 returning information indicating success to the filter management function of the OS, the setting error notification command can be guaranteed of reliably reaching the language monitor 226.

In the present exemplary embodiment, in the below-described processing performed by the language monitor 226, the print job can be reliably stopped by utilizing the mechanism of the spooler 212. Further, since the render filter 225 skips the normal print command generation processing in step S412, after the print job is stopped by the language monitor 226, the print job is quickly finished.

(Print Processing that does not Use a Form File)

FIG. 6 illustrates an example of a flowchart according to a print processing program executed by the render filter 225 in step S405 in which a form file is not used.

First, in step S601, the render filter 225 generates multi-valued raster data by performing rasterization based on a print job for a processing target page (current page). The rasterization processing may be executed either using a program provided by the printer driver 220 or a function provided by the OS.

Next, in step S602, the render filter 225 performs color conversion processing. The color conversion processing includes, for example, conversion processing into a color space that depends on the printing apparatus 230 and processing for color converting the RGB system data of an input system expressed as a luminance signal into the CMYK system data of an output system for expressing as a density signal. Further, based on the print setting information relating to the transparent ink coating method, a transparent ink plane is also generated by a method suitable for either “automatic” or “whole surface”.

In step S603, the render filter 225 performs binarization processing for quantizing the CMYK system data into one-bit data for each color. Then, in step S604, the render filter 225 converts the quantized data into a print command that can be interpreted by the printing apparatus 230, and transmits the print command thereto. The print command transmitted by the render filter 225 reaches the printing apparatus 230 via the language monitor 226, and the printing apparatus 230 forms an image corresponding to the received print command on a print medium.

Next, in step S605, the render filter 225 determines whether all pages have been processed. If it is determined that there are any remaining pages (NO in step S605), in step S606, the processing proceeds to the next page. On the other hand, if it is determined that there are no remaining pages (YES in step S605), the render filter 225 finishes the processing.

### (Form File Generation Processing)

FIG. 7 illustrates an example of a flowchart according to a form file generation processing program performed by the render filter 225 in step S410. The structure of the form file will be described below.

First, in step S701, the render filter 225 determines whether there are any incomplete form files by referring to a predetermined location in the external storage device 15. If there is an incomplete form file, the render filter 225 deletes the incomplete form file. This processing is performed in order to delete incomplete form files remaining when form file generation processing was incorrectly finished midway through, for example. Next, in step S702, the render filter 225 generates a blank form file in a predetermined location for generating the form file in the external storage device 15. In step S703, the render filter 225 writes a job header in the generated form file.

An example of the job header structure will be described in detail with reference to FIG. 9A. A job header 901 includes a version 902, a form name 903, and a total page number 904. The version 902 indicates version information relating to the format of the form file. The form name indicates the name of the form file, and stores the form name that is used in the correctness determination performed in step S409. The total page number 904 indicates the page number of the transparent ink deletion region information that is in the form file, and is stored in the below-described step S712.

In step S704, the render filter 225 writes the job header, and then checks whether there is a page having the same transparent ink deletion region in the form file. If the render filter 225 recognizes that it is processing the second or subsequent print copy, the render filter 225 may determine that the same transparent ink deletion region already exists.

If it is determined that a page having the same transparent ink deletion region exists (YES in step S704), in step S705, the render filter 225 writes a page header including information referring to the existing page, and finishes the processing of the current page. This processing not only allows the form file generation processing to be quickly completed, but also enables the size of the form file to be reduced. On the other hand, if it is determined that a page having the same transparent ink deletion region does not exist (NO in step S704), in step S706, the render filter 225 writes a page header.

An example of the page header structure will be described in detail with reference to FIG. 9B. A page header 905 includes a page ID 906, a print setting 907, a page size 908, a width 909, a height 910, and a page data position 911.

The page ID 906 is a value for uniquely identifying a page. The print setting 907 includes various setting values used when printing is executed based on a form file generation mode. The print setting 907 includes information relating to the size of the printing medium and the printing orientation. The user interface module 221 refers to the print setting 907 when the form files are displayed in a list.

The page size 908 expresses the size of the transparent ink deletion region in units of bytes. The width 909 and the height 910 express the width and the height of the transparent ink deletion region in units of pixels. The page data position 911 expresses the position of the transparent ink deletion region, and stores the offset position from the top of the form file.

When the page header has been written, in step S707, the render filter 225 generates multi-valued raster data by performing rasterization based on the print job for the current page. Then, in step S708, the render filter 225 generates binary raster data by binarizing the multi-valued raster data. In step S708, the render filter 225 binarizes a pure white region in the multi-valued raster data as “1” and a region other than the pure white region as “0”.

Next, in step S709, the render filter 225 writes the thus-generated binary raster data in the form file. The binary raster data indicates the transparent ink deletion region information for the current page. During the form composite print processing, the transparent ink is not coated in a “0” region. Thus, the non-white regions are deemed to be the transparent ink deletion regions specified by the user as the form region, and the non-white regions are all stored as a “0”.

Next, in step S710, the render filter 225 checks whether there are any remaining pages. If it is determined that there is a remaining page (NO in step S710), in step S711, the processing proceeds to the next page, and then the processing returns to step S704. On the other hand, if it is determined that there is no remaining page (YES in step S710), the processing proceeds to step S712. In step S712, the render filter 225 updates the page number stored in the job header to the latest information.

At this point, the render filter 225 adds information indicating that the form file generation processing was successfully completed. The information may be included in the job header. Further, the information may indicate that the form file generation processing was successfully completed by using a specific name to the form file. Alternatively, a management list that stores information relating to the successfully generated form files is separately generated, and the information may indicate the successful completion by being added to the list. Forms that do not have the information added in step S712 indicating that the form file generation processing was successfully completed are deleted as incomplete form files in step S701 during the next form file generation processing.

Next, in step S713, the render filter 225 closes the form file, and finishes the form file generation processing.

Thus, as described above, when the render filter 225 receives a print job in the form file generation mode, the render filter 225 generates a form that includes the transparent ink deletion region information as an external file in the external storage device 15 without supplying a print command to the printing apparatus 230.

An example of a thus-generated form file will be described in detail with reference to FIG. 9C. The job header 901 added in step S703 is provided in the top of a form file 912. After that, there are a first page header 913 and first transparent ink deletion region information 914. In the page data position 911, which is the element of the first page header 913, the position of the top of the first transparent ink deletion region information 914 is stored.

Next, a second page header 915 is provided. It is assumed that in step S704 the render filter 225 determined that second transparent ink deletion region information is the same as the first transparent ink deletion region information. In such a case, in the page data position, which is an element of the first page header 915, the position of the top of the first transparent ink deletion region information 914 is stored. This kind of page header, which refers to an existing page, is generated by the processing in step S705. Subsequently, a page header and optionally transparent ink deletion region information are repeatedly stored.

### (Form File Composite Print Processing)

FIG. 8 illustrates an example of a flowchart according to a form composite print processing program performed by the render filter 225 in step S407.

First, in step S801, the render filter 225 opens a form file, and then in step S802, reads the job header stored in the top of the form file.

Next, in step S803, the render filter 225 rasterizes the current page, and in step S804, performs color conversion processing. These processes are identical to the processing performed in steps S601 and S602 in FIG. 6. In step S804, the render filter 225 generates a transparent ink plane based on the same method as the “whole surface” method for coating the transparent ink.

Next, in step S805, the render filter 225 deletes the transparent ink based on the transparent ink deletion region information for the current page from the transparent ink plane information generated in step S804. Then, in step S806, the render filter 225 performs binarization processing, and in step S807, performs command addition processing and transmission processing. These processes are identical to the processing performed in steps S603 and S604 in FIG. 6.

Next, in step S808, the render filter 225 determines whether all pages have been finished. If it is determined that there is a remaining page (NO in step S808), in step S809, the processing proceeds on to the next page, and the processing returns to step S803. On the other hand, if it is determined that there are no remaining pages (YES in step S808), in step S810, the render filter 225 closes the form file that was opened in step S801, and finishes the processing.

### (Processing in Language Monitor 226)

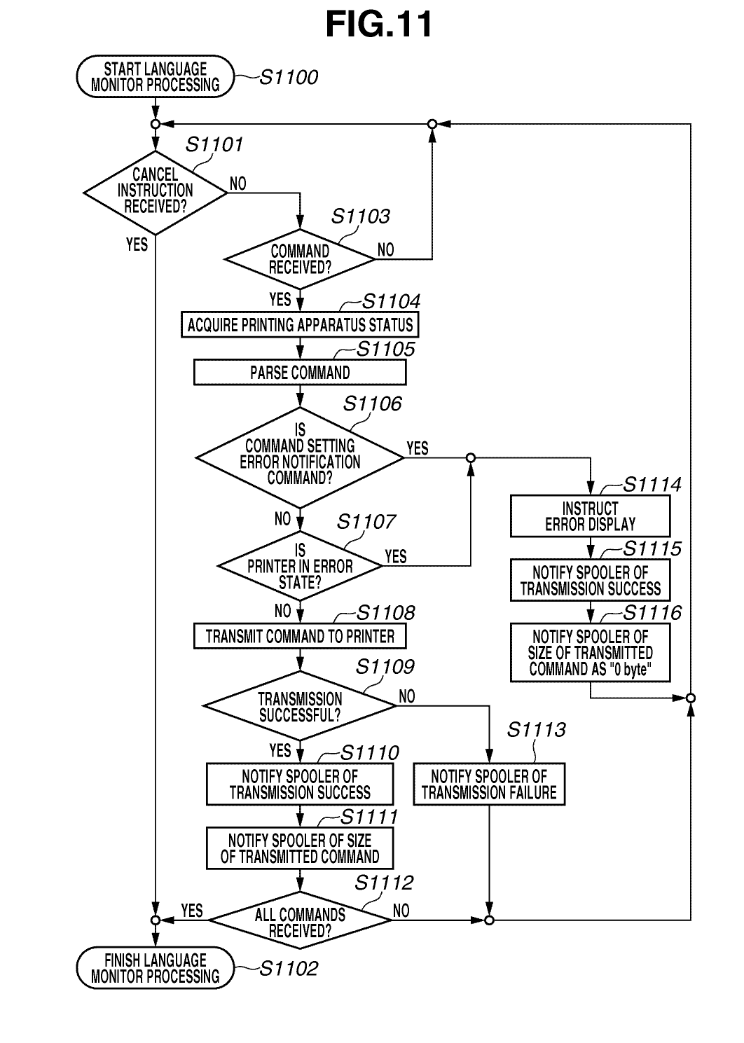

FIG. 11 illustrates an example of a flowchart according to a processing program executed by the language monitor 226.

In step S1100, the language monitor 226 is called from the spooler 212 to start the processing. In step S1101, the language monitor 226 confirms whether there is a print job cancel instruction from the spooler 212. If it is determined that there is a print job cancel instruction from the spooler 212 (YES in step S1101), in step S1102, the language monitor 226 finishes the processing. On the other hand, if it is determined that there is not a print job cancel instruction (NO in step S1101), in step S1103, the language monitor 226 confirms whether a command has been received.

If it is determined that a command has not been received (NO in step S1103), the processing returns to step S1101, and the language monitor 226 waits for a command. On the other hand, if it is determined that a command has been received (YES in step S1103), in step S1104, the language monitor 226 acquires the status of the printing apparatus 230. Then, in step S1105, the language monitor 226 performs parse processing on the received command to interpret the command.

Next, in step S1106, the language monitor 226 determines whether the command is the setting error notification command. The language monitor 226 determines that the command is the setting error notification command if “ErrorCode” is set in the data of the <notify> element 1003 of the setting error notification command 1000.

If it is determined that the command is not the setting error notification command (NO in step S1106), in step S1107, the language monitor 226 determines whether the printing apparatus 230 is in an error state based on the status of the printing apparatus 230 acquired in step S1104. If it is determined that the printing apparatus 230 is not in an error state (NO in step S1107), in step S1108, the language monitor 226 transmits a command (e.g., a print command) to the printing apparatus 230.

Next, in step S1109, the language monitor 226 determines whether the command was successfully transmitted to the printing apparatus 230. If it is determined that the command was successfully transmitted (YES in step S1109), in step S1110, the language monitor 226 notifies the spooler 212 that the command was successfully transmitted. At the same time or roughly about the same time, in step S1111, the language monitor 226 notifies the spooler 212 of the size of the command that was transmitted to the printing apparatus 230.

Next, in step S1112, the language monitor 226 determines whether all commands have been received. If it is determined that not all commands have been received (NO in step S1112), the processing returns to step S1101. The language monitor 226 repeats the processing until the all commands are received. On the other hand, if it is determined that all commands have been received (YES in step S1112), in step S1102, the language monitor 226 finishes the processing.

In step S1109, if the language monitor 226 determines that the command was not successfully transmitted to the printing apparatus 230 (NO in step S1109), in step S1113, the language monitor 226 notifies the spooler 212 that the command was not successfully transmitted, and the processing returns to step S1101.

Further, in step S1107, if the language monitor 226 determines that the printing apparatus 230 is in an error state (YES in step S1107), then in step S1114, the language monitor 226 instructs the status monitor 227 to display an error message, and then performs the processing in step S1115. The processing performed by the status monitor 227 will be described below.

In step S1106, if the language monitor 226 determines that the command is the setting error notification command (YES in step S1106), in step S1114, the language monitor 226 instructs the status monitor 227 to display the error message, and then performs the processing in step S1115. The processing performed by the status monitor 227 will be described below.

In step S1115, the language monitor 226 notifies the spooler 212 that transmission was successful. Then, in step S1116, the language monitor 226 notifies the spooler 212 that the size of the command transmitted to the printing apparatus 230 is “0 bytes”.

In the present exemplary embodiment, because the language monitor 226 performs the processing in steps S1115 and S1116, the printer driver 220 can display the error message without the spooler 212 recognizing that the print job processing failed. Further, because the language monitor 226 performs the processing in step S1115, the printer driver 220 can suspend print job processing until the user operates an operation portion on the error display. During the period until the user operates the operation portion on the error display, the language monitor 226 continues to be called from the spooler 212 and notified that the “0 byte” transmission was successful.

The error display processing performed by the status monitor 227 will be described. In step S1114, the language monitor 226 starts the status monitor 227 by a separate process so that the status monitor 227 can refer to error information. For example, file sharing may be used for inter-process communication between the modules for sharing error information.

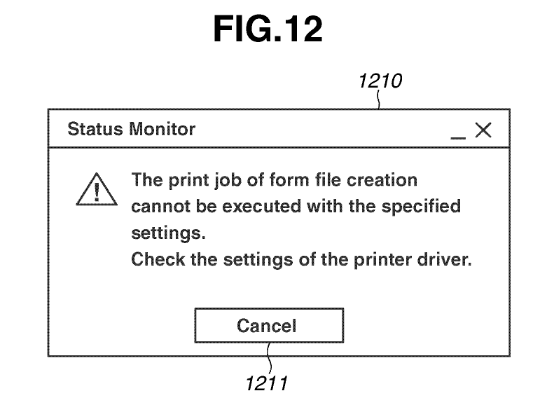

The status monitor 227 refers to the error information and displays an error screen 1210 like that illustrated in FIG. 12. When the user presses a “cancel” button 1211 via an input device, the status monitor 227 issues a print job cancel instruction.

The status monitor 227 may also request the spooler 212 to issue a print job cancel instruction by using an application programming interface (API) provided by the OS. Alternatively, the status monitor 227 may notify the language monitor 226 of the print job cancel instruction based on inter-process communication. Further, the language monitor 226 can finish the print job by notifying the spooler 212 that the size of the command determined to have been received in step S1103 has been transmitted to the printing apparatus 230.

Thus, based on the print job cancel instruction issued by the status monitor 227, the setting error notification command transmission processing is completed by the render filter 225 (or the spooler 212). Consequently, the print job is finished.

As described in the flowchart in FIG. 4, when the render filter 225 transmits the setting error notification command, the render filter 225 does not transmit any other commands before or after that. Consequently, the language monitor 226 receives the setting error notification command based on the path processing of the first command (corresponding to a YES determination in step S1106). Then, the language monitor 226 does not subsequently transmit a command to the printing apparatus 230 until the status monitor 227 issues the print job cancel instruction.

Thus, if a setting error occurs, no commands reach the printing apparatus 230. Normally, if some kind of command is received, the printing apparatus 230 starts a preparation operation for starting printing. However, when a setting error occurs, this preparation operation is unnecessary. More specifically, by configuring so that no commands are transmitted to the printing apparatus 230 when a setting error occurs, the printing apparatus 230 can avoid an unnecessary preparation operation.

According to the above configuration, even in an environment in which a print command transmitted by the render filter 225 is buffered by the filter management function of the OS or the spooler 212, the setting error notification command can reliably reach the language monitor 226. Consequently, the language monitor 226 can safely and reliably notify the user of occurrence of an error by causing endless waiting with utilizing the spooler 212 mechanism. Further, after the setting error notification command is transmitted, since the normal print command generation processing is skipped, the print job can be quickly finished after a response from the user.

If the render filter 225 directly requests the status monitor 227 to display the error message thereon, in order to reliably notify the user of the information, the render filter 225 has to perform processing which endlessly waits for a response from the user. It is not desirable for the render filter 225 to perform such processing, as this can result in the program not correctly finishing if the print job is unexpectedly finished.

Further, since the render filter 225 is called by the filter management function of the OS operating on a special process, the render filter 225 cannot by itself display the error screen for notifying the user of an error. If a configuration is provided in which a separate process is started from the filter and the print job is processed by that process, the error screen can be displayed by that process. However, in such a special configuration, that process may not be approved of as a driver that is installed in the OS.

In view of the above, according to the present exemplary embodiment, a user can be safely and reliably notified of an error even in a printing system environment using a standard OS. In the present exemplary embodiment, although the form file generation processing and the form composite print processing that use the transparent ink are described, form file generation processing and form composite print processing that do not use a transparent ink may also be employed. For example, the present exemplary embodiment can also be applied even for a form file that is used to coat color inks such as CMYK in which a transparent ink is not used.

In a second exemplary embodiment, a printing system will be described in which Windows (registered trademark) from Microsoft Corporation is used as the OS in the commonly used personal computer 1 and an enhanced meta file (EMF) data is used for the spool data. The configuration of the present exemplary embodiment is basically similar to the configuration described in the first exemplary embodiment.

However, the main difference is that in the configuration of the printer driver 220, the processing performed by the layout filter 222 and the preview filter 223 is executed by a print processor (not illustrated), and the processing performed by the render filter 225 is executed by a graphics driver (not illustrated).

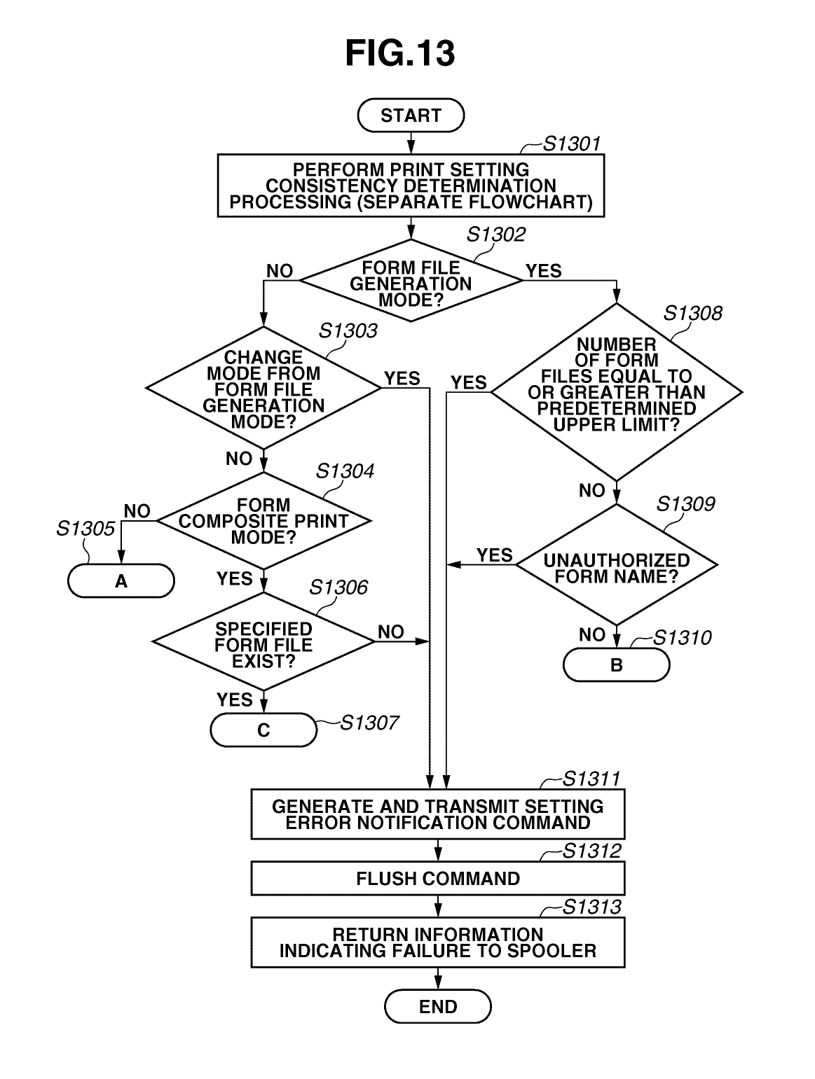

The main processing focusing on determination of a setting error relating to a transparent ink coating mode executed by the graphics driver will be described in detail with reference to FIG. 13 while focusing on the differences with the main processing performed by the render filter 225 described in FIG. 4. FIG. 13 illustrates an example of a flowchart according to a main processing program executed by the graphics driver. In the following, a description of the parts that are the same as the first exemplary embodiment will be omitted as appropriate.

The processing performed from steps S1301 to S1311 is similar to the processing performed from steps S401 to S411. In the present exemplary embodiment, means for forced transmission (flushing) of a buffered command by the spooler 212 is provided by the spooler 212. Therefore, in step S1312, the graphics driver instructs the spooler 212 to flush the command so that the setting error notification command transmitted in step S1311 can be reliably transmitted to the language monitor 226.

Consequently, the setting error notification command is guaranteed to reach the language monitor 226. Therefore, in step S1313, the graphics driver returns information indicating failure to the spooler 212, and cancels the print job.

If the respective processes in the print job are actively performed by the render filter 225 like in the first exemplary embodiment, it is easy and fast for the render filter 225 to skip some of the processes in the print job.

However, with the printer driver illustrated in the present exemplary embodiment, which uses an EMF for the spool data, the corresponding function of the graphics driver is called for every print command included in the print job.

Therefore, for the graphics driver to skip some of the processes in the print job, a mechanism for skipping the processing is necessary for all of the functions. Further, even if the processing is skipped for all of the functions, if the number of calls increases, this in itself takes up a certain amount of processing time.

Therefore, in the present exemplary embodiment, by cancelling the print job in step S1313, the print job can be finished quickly even in the printing system that uses the EMF as the spool data.

The graphics driver is started by the spooler 212. Similar to the first exemplary embodiment, since the graphics driver operates based on a special process, it cannot by itself display the error screen. Therefore, like the first exemplary embodiment, in the present exemplary embodiment too the error screen is displayed via the language monitor 226 and the status monitor 227. Consequently, according to the present exemplary embodiment, as long as the printing system uses the standard OS, a user can be safely and reliably notified of an error even in the printing system that uses the EMF as the spool data.

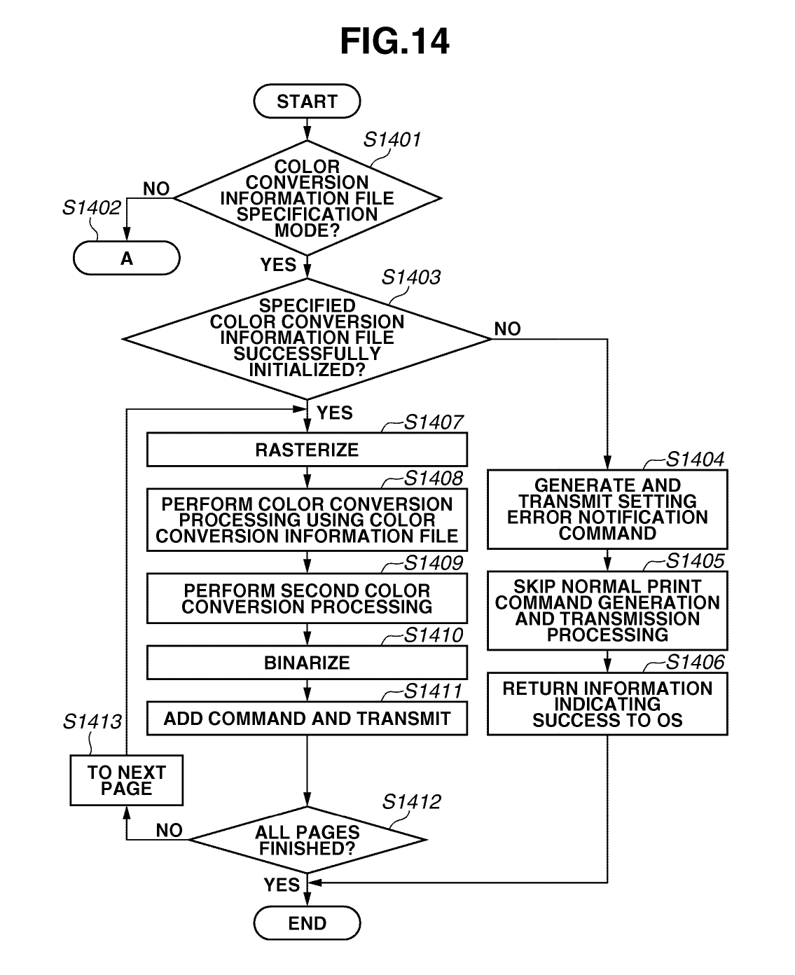

In a third exemplary embodiment, the main processing focusing on determination of a setting error relating to a color conversion information specification function executed by the render filter 225 will be described in detail with reference to FIG. 14. FIG. 14 illustrates an example of a flowchart according to a main processing program executed by the render filter 225. In the following, a description of the parts that are the same as the first exemplary embodiment will be omitted as appropriate. Further, in the present exemplary embodiment, the printing apparatus 230 may be configured to use a transparent ink or not to use transparent ink.

First, in step S1401, the render filter 225 refers to the print setting information in the print job to determine whether the mode specifies a color conversion information file. The color conversion information file is a file that stores information necessary for converting into a color space that depends on the printing apparatus 230. Although the color conversion information file is usually provided as a part of the printer driver 220, it can also be generated and provided by the user.

In the present exemplary embodiment, when the mode specifying the color conversion information file is validated via the user interface module 221, the render filter 225 can select an arbitrary color conversion information file. More specifically, when it is determined that the color conversion information file is specified, in steps S1403 to S1413, the render filter 225 performs color conversion processing using the specified color conversion information file instead of automatically executing color conversion processing based on the print setting information. Using this function enables the user to instruct the printer driver 220 to perform color conversion using the color conversion information file based on the user's intention or preference.

If it is determined in step S1401 that the mode does not specify the color conversion information file (NO in step S1401), in step S1402, the render filter 225 performs the normal print processing illustrated in FIG. 6. On the other hand, if it is determined that the mode specifies the color conversion information file (YES in step S1401), in step S1403, the render filter 225 confirms whether the specified color conversion information file can be normally initialized. This processing is performed in order to determine whether the specified color conversion information file can be used.

More specifically, the render filter 225 refers to the print setting information in the print job and acquires the file name of the specified color conversion information file. Then, the render filter 225 confirms whether the color conversion information file exists in a storage location of the color conversion information file obtained by an API provided by the OS. If it is determined that this color conversion information file exists, the render filter 225 determines that the color conversion information file can be correctly initialized.

The initialization processing may be executed either using a program provided by the printer driver 220 or a function provided by the OS. If all of the above processing could be performed normally, in step S1403, the render filter 225 determines that initialization of the specified color conversion information file was successful (YES in step S1403).

The personal computer 1 can be arranged on the same network as other personal computers via a network interface (not illustrated). The OS has a function for transferring a print job generated by the printer driver in a personal computer (client) that is not connected to the printing apparatus 230 to the printer driver operating in a personal computer (server) to which the printing apparatus 230 is connected. In such an environment, the color conversion information file specified by the user on the client may not exist on the server side.

Therefore, in the present exemplary embodiment, if it is determined in step S1403 that the initialization of the specified color conversion information file failed (NO in step S1403), the render filter 225 notifies the user of an error, and finishes the print job. The processing executed in steps S1404 to S1406 is similar to the processing executed in steps S411 to S413. Based on this processing, the print job can be quickly finished after an error has been reliably notified to the user.

If it is determined in step S1403 that the specified color conversion information file was successfully initialized (YES in step S1403), then in step S1407, the render filter 225 performs rasterization processing. This processing is similar to the processing in step S601. Then, in step S1408, the render filter 225 performs color conversion using the color conversion information file.

More specifically, using a color conversion definition generated based on the color conversion information file, the render filter 225 changes the RGB values generated by the rasterization processing. These processes may be executed using either a program provided by the printer driver 220 or a function provided by the OS.

Next, in step S1409, the render filter 225 performs a second color conversion process, which includes processing such as color converting the thus-converted RGB values into output CMYK system data for expressing as a density signal. Then, in step S1410, the render filter 225 performs binarization processing, and in step S1411, performs command addition processing and transmission processing. The processing in steps S1410 and S1411 is similar to the processing performed in steps S603 and S604.

Next, in step S1412, the render filter 225 determines whether all pages have been processed. If it is determined that there is a remaining page (NO in step S1412), in step S1413, the processing proceeds to the next page. On the other hand, if it is determined that there are no remaining pages (YES in step S1412), the render filter 225 finishes the processing.

As described above, in the present exemplary embodiment, when the initialization of the specified color conversion information file fails, by notifying the user of an error and finishing the print job, printing in which color conversion is performed in a manner different to what the user expected can be prevented.

Further, the functions in the present exemplary embodiment can also be applied to the printing system described in the second exemplary embodiment, which uses the EMF for the spool data. In this case, the processing performed in FIG. 14 is executed by a graphics driver. The graphics driver executes the processing in steps S1311 to S1313 instead of the processing in steps S1404 to S1406.

The present invention can also be realized by executing the following processing. More specifically, software (a program) for realizing the functions of the above exemplary embodiments is supplied to a system or an apparatus via a network or various storage media and a computer (or CPU or micro processing unit (MPU)) of the system or the apparatus reads and executes the program.

According to the above exemplary embodiments, a setting error in a print job can be displayed more appropriately.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-194153 filed Aug. 31, 2010, which is hereby incorporated by reference herein in its entirety.

What is claimed is:

1. An information processing apparatus which uses a management unit configured to manage a print job, the information processing apparatus comprising:
a command generation module, which includes:
a detection unit configured to detect a setting error in the print job; and
a transmission unit configured to, if it is determined that the detection unit detects the setting error in the print job, transmit a command including information about the setting error;
a command analysis module configured to, if it is determined that the command including the information about the setting error is received, request an error display; and
an error display module which includes a display unit configured to, based on the information about the setting error, display corresponding error information on a display device in response to a request from the command analysis module.

2. The information processing apparatus according to claim 1, wherein the command analysis module further includes a finishing unit configured to finish a process corresponding to the command including the information about the setting error if the command analysis module determines that a user operation is performed in response to the error information displayed by the display unit.

3. The information processing apparatus according to claim 1, wherein the command generation module is configured to instruct an operating system in the information processing apparatus to transmit the command including the information about the setting error that is stored by the management unit to the command analysis module when the command including the information about the setting error is transmitted to the management unit.

4. The information processing apparatus according to claim 3, wherein the command generation module is configured to, if it is determined that a setting error in the print job is not detected by the detection unit, perform processing for generating from the print job a print command that can be interpreted by a printing apparatus, if it is determined that the command including the information about the setting error is transmitted by the transmission unit, skip the processing for generating from the print job a print command that can be interpreted by a printing apparatus, and after skipping the processing for generating from the print job a print command that can be interpreted by a printing apparatus, instruct the operating system to transmit the command including the information about the setting error stored by the management unit to the command analysis module.

5. The information processing apparatus according to claim 1, wherein the command generation unit is configured to, when the command including the information about the setting error is transmitted to the management unit, instruct the management unit to transfer the command including the information about the setting error to the command analysis module without storing the command, and to stop processing of the print job.

6. The information processing apparatus according to claim 1, wherein if the command including the information about the setting error is received by a printing apparatus, the command is discarded without the printing apparatus performing print processing.

7. A method for displaying an error on an information processing apparatus which uses a management unit configured to manage a print job, the method comprising:
causing a command generation module to detect a setting error in the print job;
causing the command generation module to transmit, if it is determined that a setting error in the print job is detected, a command including information about the setting error;
causing a command analysis module to request, if it is determined that the command including the information about the setting error is received, an error display; and
causing an error display module to display, based on the information about the setting error, corresponding error information on a display device in response to a request from the command analysis module.

8. A computer-readable storage medium storing a computer-readable process, the computer-readable process causing a computer that uses a management unit configured to manage a print job to function as a command generation module, comprising:
a detection unit configured to detect a setting error in the print job; and
a transmission unit configured to, if it is determined that the detection unit detects the setting error in the print job, transmit a command including information about the setting error;
a command analysis module configured to, if it is determined that the command including the information about the setting error is received, request an error display; and
an error display module which includes a display unit configured to, based on the information about the setting error, display corresponding error information on a display device in response to a request from the command analysis module.

9. The computer-readable storage medium according to claim 8, wherein the command analysis module further includes a finishing unit configured to finish a process corresponding to the command including the information about the setting error if the command analysis module determines that a user operation is performed in response to the error information displayed by the display unit.

10. The computer-readable storage medium according to claim 8, wherein the command generation module is configured to instruct an operating system in the information processing apparatus to transmit the command including the information about the setting error that is stored by the management unit to the command analysis module when the command including the information about the setting error is transmitted to the management unit.

11. The computer-readable storage medium according to claim 10, wherein the command generation module is configured to, if it is determined that a setting error in the print job is not detected by the detection unit, perform processing for generating from the print job a print command that can be interpreted by a printing apparatus, if it is determined that the command including the information about the setting error is transmitted by the transmission unit, skip the processing for generating from the print job a print command that can be interpreted by a printing apparatus, and after skipping the processing for generating from the print job a print command that can be interpreted by a printing apparatus, instruct the operating system to transmit the command including the information about the setting error stored by the management unit to the command analysis module.

12. The computer-readable storage medium according to claim 8, wherein the command generation unit is configured to, when the command including the information about the setting error is transmitted to the management unit, instruct the management unit to transfer the command including the information about the setting error to the command analysis module without storing the command, and to stop processing of the print job.

13. The computer-readable storage medium according to claim 8, wherein if the command including the information about the setting error is received by a printing apparatus, the command is discarded without the printing apparatus performing print processing.
